(19) United States
(12) Patent Application Publication
(10) Pub. No.: US 2017/0308847 A1
(43) Pub. Date: Oct. 26, 2017

(54) CUSTOMER-INCLUSIVE SYSTEMS AND METHODS FOR UPDATING RETAIL PRODUCT ASSORTMENTS

(71) Applicant: Wal-Mart Stores, Inc., Bentonville, AR (US)

(72) Inventors: Jason Todd, Lowell, AR (US); Timothy W. Webb, Rogers, AR (US); Rebecca Schmalbeck, Rogers, AR (US)

(21) Appl. No.: 15/493,729

(22) Filed: Apr. 21, 2017

Related U.S. Application Data
(60) Provisional application No. 62/325,664, filed on Apr. 21, 2016.

(51) Int. Cl. G06Q 10/08

(52) U.S. Cl. CPC G06Q 10/087

(57) ABSTRACT

Embodiments relate to customer-inclusive system for updating product assortments available at retail locations. In one embodiment, such a system comprises a buyer device configured to receive a customer request for a desired product to be included in a product assortment available at a desired retail location and comprising a user interface by which a buyer can enter an order to include the desired product in the product assortment available at the desired retail location; a plurality of retail locations, at least one of the plurality of retail locations being the desired retail location and having a first product assortment that is changed to a second product assortment as a result of the order entered by the buyer, the second product assortment including the desired product; and a customer notification module configured to provide a feedback communication related to at least one of the desired product or the desired retail location to a customer.

### RELATED APPLICATION

The present application claims the benefit of U.S. Provisional Application No. 62/325,664 filed Apr. 21, 2016, which is incorporated herein by reference in its entirety.

### TECHNICAL FIELD

Embodiments relate generally to inventory management and more particularly to systems and methods for changing a product assortment available at a retail location based on customer input.

### BACKGROUND

Increasingly, retailers desire to customize product assortments in particular stores to meet their customers' needs and preferences. For example, a customer in an urban area may have different shopping needs than a customer in a rural area, and suburban stores may serve more families with children than an urban store in a commercial district. Additionally, many customers in different locations may express a preference for locally sourced products (e.g., produce), but what is local in one location is not local in another location.

Managing these customer needs and preferences is particularly challenging for retailers. Many rely on backwards-looking sales data to determine needs and preferences, without a way to gauge customer impression or preference with respect to products not currently offered. A particular product may have strong sales data in one location because it is the preferred choice among the products available there, but this provides no indication that a competing product may have even stronger sales data in that location if it was to be offered there. Conventionally, retailers rely on customer self-expression of interest in new or different products, typically by the customer finding a store employee in person on site to make a request. In large retailers, store employees typically have little or no control over product assortment decisions, and the chances of customer requests making their way from employees on the floor to buyers responsible for the proper product category at a corporate office far away are very low.

### SUMMARY

In an embodiment, a customer-inclusive system for updating product assortments available at retail locations comprises a buyer device configured to receive a customer request for a desired product to be included in a product assortment available at a desired retail location and comprising a user interface by which a buyer can enter an order to include the desired product in the product assortment available at the desired retail location; a plurality of retail locations, at least one of the plurality of retail locations being the desired retail location and having a first product assortment that is changed to a second product assortment as a result of the order entered by the buyer, the second product assortment including the desired product; and a customer notification module configured to provide a feedback communication related to at least one of the desired product or the desired retail location to a customer.

In an embodiment, a customer-inclusive method of updating product assortments available at retail locations comprises receiving by a buyer device a customer request, formulated via a customer device, for a desired product to be included in a product assortment available at a desired retail location; entering an order, via the buyer device, to include the desired product in the product assortment available at the desired retail location; updating a first product assortment to a second product assortment at the desired retail location as a result of the entered order, the second product assortment including the desired product; and providing a feedback communication to the customer device related to at least one of the desired product or the desired retail location.

### BRIEF DESCRIPTION OF THE DRAWINGS

Embodiments may be more completely understood in consideration of the following detailed description of various embodiments in connection with the accompanying drawings, in which:

FIG. 1 is a block diagram of a crowd sourced inventory system according to an embodiment.

FIG. 2 is a flowchart of a method according to an embodiment.

FIG. 3 is a flowchart of a method according to an embodiment.

While embodiments are amenable to various modifications and alternative forms, specifics thereof have been shown by way of example in the drawings and will be described in detail. It should be understood, however, that the intention is not to be limited to the particular embodiments described. On the contrary, the intention is to cover all modifications, equivalents, and alternatives falling within the spirit and scope of the appended claims.

### DETAILED DESCRIPTION

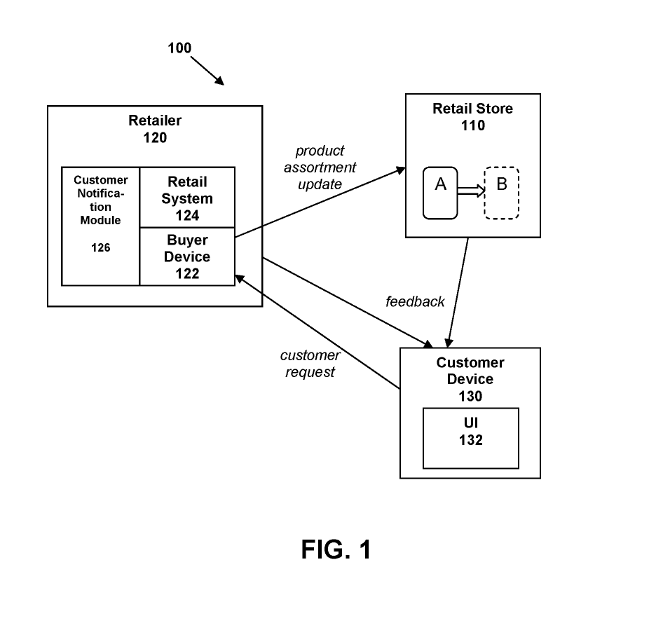

Referring to FIG. 1, a customer-inclusive product assortment updating system 100 is depicted. In one embodiment, system 100 comprises a retail store 110, a retailer 120 and a customer device 130.

Retail store 110 can be virtually any retail outlet, including a physical, brick-and-mortar storefront, an internet-based outlet, a hybrid of the two, or some other setting or location via which a customer may purchase or obtain products. FIG. 1 includes only a single retail store 110, but in many cases system 100 includes a plurality of retail stores 110. In one embodiment, system 100 comprises a plurality of retail stores 110, with some of the plurality of retail stores 110 being brick-and-mortar storefronts and at least one of the plurality of retail stores 110 being an internet-based website store.

Each retail store 110 has a product assortment, shown in FIG. 1 as A. Product assortment A typically comprises each and every individual product offered for sale at that retail store 110. For example, product assortment A would include not just “milk” but half-gallon skim milk from Brand X, half-gallon skim milk from Brand Y, gallon skim milk from Brand X, gallon skim milk from Brand Y, half-gallon 1% milk from Brand X, etc. In other words, product assortment A is item-specific, rather than category-specific, and does not necessarily reflect stock inventory (e.g., 50 count of Item K) so much as the list of items on offer (e.g., Item K, Item L, Item M). In other embodiments, this may vary depending on the type of retailer, as the granularity may vary depending on the type of retailer.

Retail store 110 is associated with retailer 120. Retail store 110 can be a subsidiary, franchise, owned outlet, or other affiliate of retailer 120. Retailer 120 can be a home office or headquarters of a company, or some other affiliate, and often is located apart from retail store 110. In some embodiments, retailer 120 can be partially or fully co-located with retail location 110. For example, retailer 120 can host some or all of an internet-based website store 110. In another example, retailer 120 and a brick-and-mortar retail store 110 can be co-located.

In general, retailer 120 has partial or complete responsibility for making buying and product assortment decisions for retail store 110. One or more buyers working at or otherwise associated with retailer 120 typically make these decisions for some or all of the retail locations 110. For example, one buyer or a team of buyers may be responsible regionally, nationally or even internationally for making all buying decisions related to cosmetics, while another buyer or team is responsible for produce, and another for housewares, etc. Buyer responsibilities can vary among product categories, retailers or based on other factors, and the particularities of how those responsibilities are divided or assigned is not important, beyond that at some level there is someone associated with retailer 120 who has buying and product assortment responsibilities for retail store 110.

To facilitate these responsibilities, the buyer is associated with a buyer device 122. In FIG. 1, buyer device 122 is depicted as being part of or located with retailer 120, but in various embodiments buyer device 122 can be located elsewhere, including at retail store 110 in one embodiment. In some embodiments, buyer device 122 can comprise a mobile device, such as a laptop, tablet, smartphone or other mobile computing device. Buyer device 122 can communicatively interact with or form part of a retail system 124, such as an intranet, cloud-based server system or local network associated with the retailer. Retail system 124 can comprise analytics and interest engines and modules, including a customer notification module 126, among others, and buyer device 122 and retail system 124 can share data and information. In general, buyer device 122 is a computing device provided with or able to access software, programs or other tools, including those of retail system 124, in order to carry out buying-related tasks and communicate with other devices, including customer device 130.

Customer device 130 is associated with a customer. One customer device 130 is depicted in FIG. 1, but in embodiments system 100 can interface with or include a plurality of customer devices 130, including thousands or millions of customer devices 130 that interact with system 100. Customer device 130 can comprise a computer, a laptop, a tablet, a smartphone, a wearable computing device, or some other computing device via which a customer can send or receive information in system 100. In still other embodiments, customer device 110 can comprise a computer, kiosk or other device located at retail store 110. In an example embodiment that will be used herein, customer device 130 comprises a smartphone loaded with a mobile application (or “app”) associated with retailer 120 and interfacing with one or both of retail system 124 and buyer device 122. Mobile apps other than those associated with retailer 120 and retail store 110 can be used in embodiments (e.g., shopping list management apps), and the example used herein is not limiting with respect to these and other embodiments. For example, a smartphone or other computing device can be used to access a website of retailer 120 via which information can be provided. In general, however, customer device 130 will comprise or present a user interface 132 by which the customer can send and receive information.

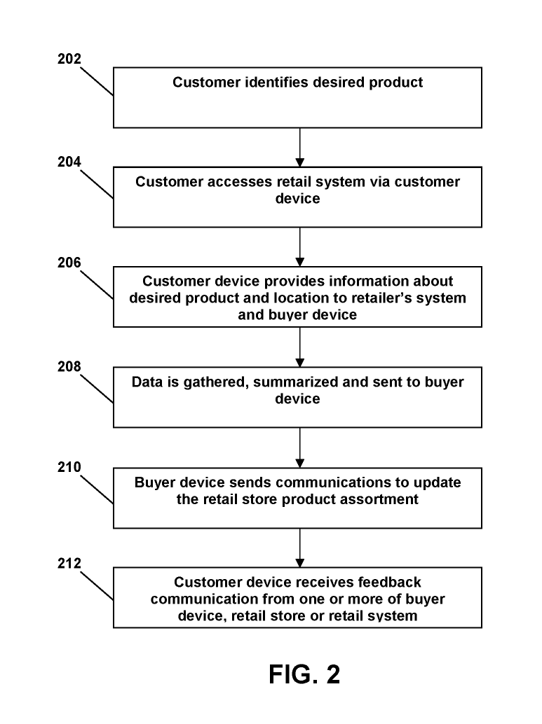

In embodiments, a customer uses customer device 130 to provide information to retailer 120, in particular buyer device 122, regarding a desired product. Referring also to FIG. 2, a customer identifies a product of interest to them at 202. The customer may have visited retail store 110 in search of a particular product they could not find, noticed a product at another retail store that is not available at their desired retail store 110, found a product online that they would like to be able to purchase at their desired retail store 110, or otherwise become aware of a product that they would like to be able to purchase at their desired retail store 110. While the product can be specific (e.g., Brand Z organic creamy almond butter), it also can be more general (e.g., locally sourced organic tomatoes).

At 204, the customer accesses the retailer system 124 via customer device 130 or another retailer portal. As previously discussed, this can be done by accessing a website of retailer 120, using a mobile app of retailer 120, using a kiosk in retail store 110, or in some other way. In this example, the customer uses a smartphone (customer device 130) to access a mobile app of retailer 120. As previously discussed, customer device 130 comprises user interface 132 by which the customer can provide this and other information to, and receive information from, retail system 124 and/or buyer device 122. Accessing the mobile app can include or require creating an account or profile, providing contact information, selecting a home store (retail store 110), setting other preferences (notifications permitted, text vs. email, etc.), entering demographic or other information (e.g., sex, marital status, children and ages, pets and type, hobbies, interests, dietary needs, etc.), accepting use terms, and other tasks.

At 206, the customer provides information about the desired product and desired location via user interface 132 of customer device 130. In one embodiment, the mobile app can include a form or section specifically for making a desired product request, presented on user interface 132. In other embodiments, the app can present a note, email, text, form, or other communication in which the customer can provide information. The information provided about the desired product can take a variety of forms, including one or more of a digital photo, a digital video, a hyperlink, freeform text, a voicemail or other audio recording, or other information. In one embodiment, the customer can scan a barcode of a desired item using customer device 130. For example, the customer can provide a digital photo of a product located on the shelf of another retail location, along with free form text explaining the request (e.g., a photo of Brand Z organic creamy almond butter and text “this brand is a better value” or “I cannot find ORGANIC creamy almond butter in my retail store”). Or, a customer can copy and paste a hyperlink to the product being sold online from another retailer. Still other requests can relate to product categories (e.g., “please carry locally sourced fresh berries”) or more general requests for a product type as opposed to a specific product.

The customer also provides the desired retail store 110 at 206. In one embodiment, this information can be provided automatically or by default if the customer has identified a home store in their profile or if location services are enabled on customer device 130 such that the retailer's system can determine the customer's location and select the closest retail store. In such an embodiment, customer device 130 can present the name and address of the store or several nearby stores and ask for confirmation by the customer of the desired store. Various other ways of obtaining or confirming the desired retail store 110 also can be used in embodiments.

This information is gathered, summarized and sent to buyer device 122 at 208. In some embodiments, individual customer information provided at 206 is first sent to retail system 124 for gathering and summarizing before being filtered and sent to the most appropriate buyer device(s) 122. In addition to gathering and summarizing, retail system 124 and/or buyer device 122 can also analyze the information from a plurality of customers for trend spotting or other purposes. For example, retail system 124 could analyze bulk customer product request data and identify that a significant percentage of customers are requesting the same product or type of product. Retail system 124 or a buyer using buyer device 122 could review this data to see that a new item is available and make a determination that it should be carried in a large number of or all retail stores 110 based on its popularity and likelihood of success. In another example, it could be determined that a significant number of customers at one or more closely located retail stores 110 are requesting pool accessories, because a new community pool recently opened. The buyer could use this information, provided via buyer device 122, to also add additional sunscreens, coolers, beach towels or other complementary products to those retail stores 110. In embodiments, one or both of buyer device 122 and retail system 124 can provide suggestions for complementary products like this based on additional data analysis. In other embodiments, some or all of the gathering and summarizing is performed by buyer device 122.

Based on data at 208, the buyer then updates the retail store product assortment from product assortment A to product assortment B at 210, via buyer device 122. This can include communications between buyer device 122 and other systems, including retail system 124 and external systems of retailer 120 (e.g., ordering systems, provider or distributor systems, etc.), and typically also includes communication between buyer device 122 and retail store 110 to notify retail store 110 of the change. Upon receiving such notification, retail store 110 personnel may need to make arrangements to accommodate product assortment B, including physical changes within retail store 110. For example, a display module may need to be added or expanded, shelf and inventory space may need to be found, signage may need to be obtained, computer systems may need to be updated, employees may need to be educated regarding the new product assortment B, and other tasks. Thus, a physical, tangible result is provided by the change from product assortment A to product assortment B at retail store 110 at 210, as a result of the original customer request.

At 212, the customer receives feedback via customer device 130 about their original request from customer notification module 126. This feedback can be from or initiated by customer notification module 126, which can instead or additionally be located at one or more of the retail store 110, or by the buyer via buyer device 122 or retail system 124, and the feedback can be a personal communication directed to only that customer or it can be a mass communication directed to a plurality of customers, such as customers who have identified retail store 110 as their home store, customers who have made similar product requests, customers who have expressed interested in the same, similar or complementary products, or other sets or subsets of customers. For example, in one embodiment the buyer initiates a communication sent by customer notification module 126 to customer device 130, to thank the customer for their request and let them know that the new product will be offered in retail store 110. The communication can include other information, such as an estimated availability date, pricing information, in-store location information, complementary product information, coupons or special offers, or other information. Separately, retail store 110, via the same or its own customer notification module 126 or in some other way, can send a communication to customer device 130 to let the customer know when the product is available or other information, including the information mentioned above. Thus, the customer, via customer device 130 and system 100, can receive confirmation or closure of the request.

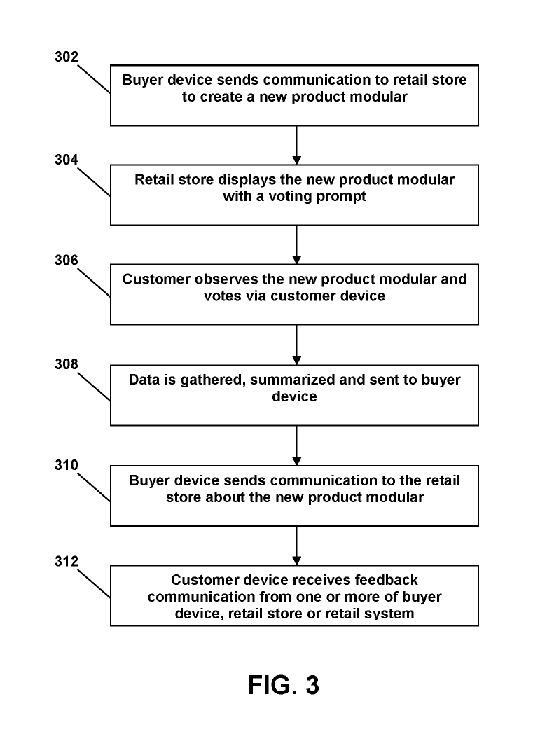

Another customer-inclusive method for updating retail product assortments using system 100 is depicted in FIG. 3. Rather than being initiated by a customer request, via customer device 130, for a desired product as in the previous example, in FIG. 3 a product modular is presented in a store in order to seek customer feedback, such as by voting, about one or more characteristics of the product modular. In other embodiments, items other than product modulars can be presented or identified for voting, such as products, brands, layouts, offers, or other items or characteristics related to retail store 110 or the retailer more generally. In the example discussed herein, a new product modular displayed in retail store 110 will be used, but this is used merely as one example.

At 302, the new product modular is initiated, such as by a communication from buyer device 122 to retail store 110. In other embodiments, the communication can be sent by retail system 124, or the product modular can be initiated in some other way, such as directly by retail store 110 itself.

At 304, the new product modular is displayed at retail store 110. The product modular can comprise a variety of different formats, such as a display on a portion of shelving, a stand-alone or pop-up display unit, or some other physical structure for displaying one or more products. The modular can present one or more products, such as one or more of new products, existing products, special or limited edition products, holiday products, regional interest items or products, new displays of complementary products, or some other product or assortment of products, including combinations of the aforementioned products or items. The product modular also can include a sign or other prompt requesting that customers vote or otherwise provide feedback about the modular and/or its contents. The prompt can include instructions for accessing a mobile app, website or other place for voting, and in one embodiment the prompt can comprise a QR code that a customer can scan with their phone to take them to a voting portal. In still other embodiments, voting can be initiated automatically on via a customer device 130 and a communications module in the product modular that detects proximity of a customer with the retailer's mobile app installed. The prompt also can include a tear-off form or note for a customer to take home and from which a website, phone number or other information can be used to access the voting portal. In yet another embodiment, a kiosk or voting station can be integrated with the product modular or provided proximate the product modular or elsewhere in retail store 110. In still another embodiment, store personnel may be positioned proximate the product modular to invite or encourage customers to vote. In one particular example, store personnel can provide samples related to the product modular and information for customers accepting the samples regarding where and how to provide feedback. In other words, a wide variety of techniques and ways to make customers aware of the opportunity to vote related to product modular and/or its contents can be provided.

At 306, a customer at retail store 110 observes the product modular and accesses the system of retailer 120 to vote. As previously discussed in relation to FIG. 2, this can be via customer device 130 or another retailer portal, including in some way consistent with the various voting prompts discussed above related to task 304. Thus, the customer, via customer device 130, can access a website of retailer 120, use a mobile app of retailer 120, use a kiosk or other device in retail store 110, or provide a vote or other requested feedback about product modular in some other way. In one example, the customer uses a smartphone (customer device 130) to access a mobile app of retailer 120. As previously discussed, customer device 130 comprises user interface 132 by which the customer can vote and provide other information, and receive information. Accessing the mobile app can include or require creating an account or profile, providing contact information, selecting a home store (retail store 110), setting other preferences (notifications permitted, text vs. email, etc.), accepting use terms, and other tasks.

The information sought in the voting can vary and involve the customer voting yes/no, answering questions (e.g., is it helpful to display ground coffee and coffee creamer together in the product modular?), or providing freeform feedback. From customer device 130 or whatever device or source the customer uses to provide their feedback, the data and information are gathered, summarized and sent to retailer 120, specifically one or both of retail system 124 and buyer device 122 at 308. As previously discussed in relation to FIG. 2, in some embodiments individual customer information provided at 306 is first sent to retail system 124 for gathering and summarizing before being sent to the most appropriate buyer device(s) 122. In addition to gathering and summarizing, retail system 124 and/or buyer device 122 could also analyze the information from a plurality of customers for trend spotting or other purposes. In cases in which specific questions are asked or voting options posed, the results from a plurality of customers can be aggregated as part of the gathering and summarizing. Thus, the information provided to buyer device 122 could be quite simple (e.g., 82% of customers like the new product modular, or 65% of customers found it helpful to have ground coffee and coffee creamer displayed together in the product modular), or it could be more complex (e.g., a first customer requested flavored creamers be included in the product modular, a second customer requested removing artificial sweeteners from the product modular, a third customer requested locating the product modular near the coffee makers, etc.), depending on the type of feedback sought and/or received.

After reviewing this information, the buyer can send, from buyer device 122 and/or retail system 124 to retail store 110, a communication regarding the new product modular at 310. The communication can include instructions or suggestions for doing one or more of removing the modular, replacing the modular, repositioning the modular, adding/deleting/expanding/editing the items in the product modular, or taking some other action related to the product modular or its contents. In one example, the communication from buyer device 122 to retail store 110 can instruct retail store 110 personnel to update product assortment A to product assortment B by adding a product from the product modular to the regular product assortment carried in the store.

At 312, any customers who voted or provided information at 306 can receive a feedback communication. As previously discussed with respect to FIG. 2, this feedback communication can be from or initiated by customer notification module 126 at retailer 120 or one or more of the retail store 110, the buyer via buyer device 122 or retail system 124, and the feedback can be a personalized communication directed to an individual customer or it can be a mass communication directed to a plurality of customers. For example, in one embodiment the buyer sends a communication to the customer, from customer notification module 126 to customer device 130, to thank the customer for participating in the voting and to let them know about any changes that will be implemented at retail store 110 related to the product modular. The communication can include other information, such as an estimated availability date of new products or changes, pricing information, in-store location information, complementary product information, coupons or special offers, or other information. Separately, retail store 110 can send a communication from customer notification module 126 or in some other way to customer device 130 to let the customer know when the changes are implemented or other information, including the information mentioned above. Thus, the customer, via customer device 130 and system 100, can receive confirmation of or closure to the voting process.

In embodiments, the communications sent at 212 or 312 can include additional features, such as offers to subscribe the customer to future communications from retailer 120, buyer device 122 and/or retail store 110. These communications can be managed by customer notification module 126 in one embodiment and can be filtered so that selected customers receive particular or desired communications. The offers also can be provided via a mobile app or at another point in the process, such as at 204/206 or 306, or in other communications. In some embodiments, customers can choose a type of information they would like to receive, such as general communications from retailer 120, communications specific to their home retail store 110, communications with special offers, communications regarding products they like or products complementary to products they like, communications regarding topics of interest, communications regarding in-store events, or other types of communications. For example, if the customer has requested, at 206, that retail store 110 carry pool toys, then retailer 120, via customer notification module 126, and/or retail store 110 can provide communications with offers for other swimming accessories and barbeque tools and food items, if retail system 124 and/or buyer device 122 have correlated these items (i.e., customers that purchase pool toys often have pools and host pool parties at which they barbeque). In embodiments, these communications also can solicit voting or feedback from customers, similar to that which is sought at 306. In this way the buyer, via buyer device 122, can continue to obtain and refine information to enable updating of the product assortment offered at 110 while also improving the type and content of communications sent to customers. These communications also can enable the retailer to promote products, specials and events at the right level and to customers likely to be receptive to the communications and promotions.

In still other embodiments, data and information obtained via system 100 can be aggregated and analyzed beyond that related to a particular retail store 110 or buyer. In this way retailer 120 and its buyers as a group can obtain and share information that enable them to consider product assortment refinements across a wider area or with respect to a broader issue.

In various embodiments, including those discussed above, system 100 provides proactive, rather than conventional reactive, ways for buyers, retailers and retail stores to fine-tune their offerings and product assortments, thereby more effectively meeting their customers' needs and desires. By providing ways in which customers and requests can be localized to particular stores, system 100 provides ways for buyers and retailers to create stores that reflect their individual communities and individual customers by providing desired products at desired locations.

In embodiments, system 100 and/or its components or systems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A customer-inclusive system for updating product assortments available at retail locations, comprising:
a buyer device configured to receive a customer request for a desired product to be included in a product assortment available at a desired retail location and comprising a user interface by which a buyer can enter an order to include the desired product in the product assortment available at the desired retail location;
a plurality of retail locations, at least one of the plurality of retail locations being the desired retail location and having a first product assortment that is changed to a second product assortment as a result of the order entered by the buyer, the second product assortment including the desired product; and
a customer notification module configured to provide a feedback communication related to at least one of the desired product or the desired retail location to a customer.

2. The system of claim 1, wherein the customer notification module is accessible at one of the plurality of retail locations.

3. The system of claim 1, wherein the at least one of the plurality of retail locations being the desired retail location is configured to receive information about the second product assortment as a result of the order entered by the buyer via the user interface of the buyer device.

4. The system of claim 1, wherein the feedback communication comprises information related to availability of the second product assortment.

5. The system of claim 1, wherein the feedback communication comprises information related to a product complementary to the desired product.

6. The system of claim 5, wherein the information related to a product complementary to the desired product comprises at least one of an availability of the complementary product; an existence of the complementary product; a coupon related to the complementary product; a use of the complementary product; a use of the complementary product related to the desired product; an origin of the complementary product; a previous purchaser of the complementary product; or a characteristic of at least one of the complementary product or the desired product.

7. The system of claim 1, further comprising a customer device communicatively coupled with the buyer device to send the customer request and with the customer notification system to receive the feedback communication.

8. The system of claim 7, wherein the customer device comprises a user interface by which the customer can include information for the buyer about the desired product.

9. The system of claim 8, wherein the information for the buyer about the desired product comprises at least one of a photo, a text note, barcode information, or a web link.

10. The system of claim 7, further comprising a retail system communicatively coupled with the customer device and the buyer device and configured to aggregate data from a plurality of customer devices and communicate information related to the aggregated data to the buyer device.

11. The system of claim 10, wherein the customer device is configured to accept a customer vote related to at least one of the desired product, the first product assortment, the second product assortment, or one of the plurality of retail locations, and wherein the retail system is configured to aggregate votes from a plurality of customer devices and communicate information related to the aggregated votes to the buyer device.

12. The system of claim 7, wherein the customer device comprises a user interface by which the customer can subscribe to receive information from at least one of the buyer, the desired retail location, the plurality of retail locations, or an entity associated with the plurality of retail locations.

13. The system of claim 7, wherein the customer device comprises at least one of a computer, a laptop, a mobile phone, a smart phone, a smart watch, a tablet device, an electronic reading device, a kiosk, a television, a camera, an appliance, or an instant product ordering device.

14. A customer-inclusive method of updating product assortments available at retail locations, comprising:
receiving by a buyer device a customer request, formulated via a customer device, for a desired product to be included in a product assortment available at a desired retail location;
entering an order, via the buyer device, to include the desired product in the product assortment available at the desired retail location;
updating a first product assortment to a second product assortment at the desired retail location as a result of the entered order, the second product assortment including the desired product; and
providing a feedback communication to the customer device related to at least one of the desired product or the desired retail location.

15. The method of claim 14, further comprising providing access for the customer device to a system by which the customer can formulate the customer request.

16. The method of claim 15, wherein providing access for the customer device further comprises providing access to a system by which the customer can provide at least one of an image, a text note, or a web link related to the desired product.

17. The method of claim 15, wherein providing access for the customer device further comprises providing access to a customer notification module by which the customer can subscribe to receive information from at least one of the desired retail location or an entity associated with the desired retail location.

18. The method of claim 14, further comprising:
receiving electronic customer votes related to at least one of the desired product, the first product assortment, the second product assortment, or the desired retail location;
aggregating the electronic customer votes; and
communicating information related to the aggregated electronic customer votes to the buyer device of a buyer associated with the desired product or the desired retail location.

19. The method of claim 14, wherein providing a feedback communication to the customer device further comprises providing information related to a product complementary to the desired product.

20. The method of claim 19, wherein providing information related to a product complementary to the desired product comprises providing at least one of an availability of the complementary product; an existence of the complementary product; a coupon related to the complementary product; a use of the complementary product; a use of the complementary product related to the desired product; an origin of the complementary product; a previous purchaser of the complementary product; or a characteristic of at least one of the complementary product or the desired product.

21. The method of claim 14, further comprising:
filtering received customer requests; and
communicating information related to the filtered customer requests to the buyer device of a buyer associated with the desired product or the desired retail location.
